(19) United States
(12) Patent Application Publication
(10) Pub. No.: US 2002/0040335 A1
(43) Pub. Date: Apr. 4, 2002

(54) Maintenance fee recovery program

(76) Inventors: Victor E. De Veux, Glendale, AZ (US); Patricia M. De Veux, Glendale, AZ (US)

Correspondence Address: V.E. DEVEUX & ASSOCIATES, LLC, P.O. Box 6594, GLENDALE, AZ, 85312, US

(21) Appl. No.: 09/788,577

(22) Filed: Jul. 31, 2001

Related U.S. Application Data
(60) Provisional application No. 60/186,315, filed on Mar. 2, 2000.

(51) Int. Cl. G06F 17/60

(52) U.S. Cl. 705/35

(57) ABSTRACT

As a licensed Real Estate Broker, a former Real Estate Regulator in Arizona and a licensed Community Association Manager in Florida, the procedures are outlined in the “Text” for the Maintenance Recovery Program. It has been formulated over the last eighteen years ro protect both buyers and sellers of the time share interval, which, at the last estimate is approximately three point six (3.6) million in the USA and approximately four point five (4.5) in the world and growing. The average price is $ 15,000 to over $ 25,000 per interval (week). The average yearly maintenance fee is approximately $ 400.00 per interval week owned per year.

If a purchaser of a time share interval could recoup their maintenance fees and the Home Owners Association would be able to eliminate costly foreclosure proceedings it would then benefit all parties concerned.

Due to the overwhelming number of Time Share opportunities currently available in the market, management and marketing companies alike are looking for new ways to enhance the value of their particular package. They are looking for ways to set themselves apart from the competition. In addition, marketing companies are always looking for “button up” ideas when attempting to close a deal. These ideas must also be as inexpensive as possible, in order to keep profits and margin up. The Maintenance Fee Recovery Program is the creative financing idea that can accomplish this. The principal is simple, yet effective. Here is how it works.

When a buyer signs the agreement he is offered an option of pre-paying the annual maintenance and Title Company fee. Since these fees must be paid each year regardless of the method, the buyers choice is to either pre-pay the fees, or pay them annually.

When using the prepayment option, the HOA (Home Owners Association) takes the pre-payment portion (usually 7 or 10 years times the monthly fees) upon closing, much like a bank receives the closing costs in a mortgage. These monies are invested by the HOA in a special trust specifically set up to legally protect their not-for-profit status.

In return for the pre-payment, the HOA guarantees the buyer that a certain number of yearly HOA dues will be covered. How many years the pre-payment will cover depends upon the current rate of return, but it must always be attractive enough to encourage the buyer to prepay.

The pre-payment option is advantageous to the buyer, the management company, and the Home Owners Association. The buyer receives a number of years maintenance free, plus he has a certain marketable equity in the pre-payment money. This equity can be transferred to another buyer should he sell his interest in the Time Share. The management company has a tool to assist in closing the deal. The HOA has their fees prepaid eliminating collection costs and defaults.

Everyone wins!

Following are three examples of how this can work financially. The first shows the growth of the seven year pre-payment at various interest rates while it is in the trust account. The second set of data shows the same investment with an additional $100/yr. Title Company Disbursement Fees (or Trust Company Disbursement Fees) deducted from the account.

All calculations are based on simple interest compounded annually.

EXAMPLE

Mr. New Owner chose the 10 year pre-payment option. He pays an additional $2800 at closing (this covers 7 years). since he is now guaranteed 10 years of dues, he has already made a profit of $1200.

The HOA puts the money in the Trust and has a 13% annual return on their investment. At the end of 10 years the HOA can pay an additional $295 to Mr. New Owner. In addition, during the past 10 years, the HOA has had no collection or billing expense for this account.

If the HOA has only a 12% return on the investment they may bill for the remaining $78.00.

[image]

[image]

[image]

### Proposed Procedures for Foreclosure of Existing Time Share Interval

Example: Mill Farm* Resort HOA, Inc., a not for profit corporation.

Assuming a 100 unit project (5,100 intervals), each interval sold for $12,000 plus $400 maintenance fee. Out of the 5,100 intervals, HOA has to foreclose on 400 intervals and they lose approximately $160,000 a year in maintenance fees. They must sell these intervals as quickly as possible.

#1 They (Mill Farm HOA) could hire a licensed Broker to market and sell the intervals for $10,000.

A. The Broker receives a 20% commission ($2,000).

B. The purchaser would then be required to pay the $400 maintenance fee.

NOTE: This procedure has been used with very little success.

#2 The HOA could market the intervals for $10,000 (no commissions, only costs as HOA is a non-profit organization). Built into the $10,000 price would be the maintenance fee of $400 per interval year at seven ($2,800 total). There would be NO DOWN PAYMENT, the $10,000 would be financed at 14%, $2,800 would be placed in a third party trust at close of escrow. The interest would be given to the purchaser, less costs as per the agreement, and paid annually to HOA which would eliminate the maintenance fee for the purchaser. The HOA could then sell the remaining note at a discounted rate.

Time Share—CC&Rs requires a Home Owners Association (HOA) registered with the Corporation Commission as a non-profit corporation. This presentation is to address maintenance fees, marketing and profitability.

Assuming a developer is planning to build a 200 unit time share project, all the units will be 2 bedroom, 2 bath, approximately 1,200 square feet fixed unit floating time. There are 10,200 intervals leaving one week for maintenance, which is the standard procedure.

Assuming an interval sells for $15,000×51 weeks=$765,000×200=$153,000,000 gross for the developer, which will probably sell out within three to five years in today's market. The maintenance fee per unit is approximately $400 per interval, paid annually. Four hundred ($400)×51 intervals is $20,400 per unit or $4,080,000 for 200 units.

As mentioned before, the Home Owners Association is a non-profit corporation. The maintenance fees are $400 per interval. The cost to the buyer is $400 per year or $2,800 over a seven year period.

I address your attention to the following copyrighted material regarding Home Owners Association and the Maintenance Fee Recovery Program.

THE ABOVE LISTED PROCEDURE WOULD NOT ONLY BENEFIT THE PURCHASER, BUT ALSO THE “HOA”, AS THEY WOULD BE GUARANTEED THE MAINTENANCE FEE FOR SEVEN YEARS. ON THE RESALE, NO FINANCIAL ASSURANCES WOULD BE REQUIRED. THIS PROCEDURE SHOULD BE REPEATED EVERY SEVEN YEARS ELIMINATING PAYMENT OF MAINTENANCE FEES FOR THE PURCHASER.

In the event that the sale price cannot be marketed, sell the interval for cost and guaranteed maintenance fees.

NOTE: Documentation over the years indicates that time shared tours account for approximately 10% sales. I believe this procedure would generate at least 20% to 30% more sales.

### The Below Listed Procedures are Based on Gross Profit

At the present time there are 51 interval weeks and one interval week for maintenance for a total of 52 intervals per unit. Sales price of $15,300 per interval×51=$780,300×112 units=$87,393,600. Maintenance fees of $400 per interval×51 interval weeks=$20,400=112 units=$2,284,800. The units are sold as fixed units with floating time. (All units are 2 bedroom, 2 bath, including lock off.)

### In Comparison

Fifty-two (52) intervals per unit can legally be sold and have no specific maintenance period for the entire project if the following procedures are used.

Example: 52 intervals×112 units=5,824 intervals.

Total gross figure would be $795,600 per unit×112 units=$89,107,200 gross sales, realizing an additional $1,713,600 in gross sales.

1. We claim that the subject material (the “text”) is a useful procedure for the sale, resale and foreclosure of existing time share intervals under the maintenance fee recovery program:
When instituted, it will eliminate foreclosure, HOA (Homeowner Association) expenses due to legal fees incurred by foreclosure and for lack of payments due for maintenance association fees..
The tangible results will be for the buyers, sellers, HOA (Home Owners Association) and the Investor in the Time Share Projects making it a win - win situation for all.
